(19) United States
(12) Patent Application Publication
(10) Pub. No.: US 2019/0266648 A1
(43) Pub. Date: Aug. 29, 2019

(54) SYSTEMS AND METHODS FOR ANALYZING CONSUMER PRODUCTS

(71) Applicant: Roman Bleichenbacher, Rümlang (CH)

(72) Inventor: Roman Bleichenbacher, Rümlang (CH)

(21) Appl. No.: 16/005,587

(22) Filed: Jun. 11, 2018

Related U.S. Application Data
(60) Provisional application No. 62/634,938, filed on Feb. 26, 2018.

(51) Int. Cl. G06Q 30/02; G06Q 30/06

(52) U.S. Cl. CPC G06Q 30/0282; G06Q 30/0621

(57) ABSTRACT

Systems and methods for analyzing consumer products, such as food products and cosmetics, are disclosed. The systems include a server that includes a central processor and memory facilities, which is operably connected to a plurality of databases that house product-specific data. The server includes a computing module, which is configured to receive personalized consumer product criteria from each of a plurality of users (e.g., through a centralized website); extract the product-specific data from each of the plurality of databases; and compute a product rating based on the personalized consumer product criteria and product-specific data. The product rating is then communicated and displayed to the user.

### CROSS-REFERENCE TO RELATED APPLICATIONS

This application claims priority to, and incorporates by reference, U.S. provisional patent application Ser. No. 62/634,938, filed on Feb. 26, 2018.

### FIELD OF THE INVENTION

The field of the present invention relates to systems and methods for analyzing consumer products. More particularly, the present invention relates to systems and methods for rating the ingredients, components, and/or other aspects of certain consumer products (including, but not limited to, foods, cosmetics, washing products, and pet products), based on certain personalized criteria specified by a user and information extracted from external/third party sources.

### BACKGROUND OF THE INVENTION

Consumers are increasingly wanting to know more about the products they are consuming and/or using—particularly products that may have a direct impact on health, wellbeing, and/or the environment. Conventional methods are often used to measure the quality and health aspects of such products, in terms of a consumer's requirements and preferences. Such conventional methods often involve, for example, reading the ingredient and nutritional information that is affixed to a product container or label. However, such conventional methods are entirely reliant upon the consumer understanding the full relevance of such ingredient and nutritional information (and, furthermore, such conventional methods do not convey the impact on the environment).

Accordingly, there is a demand for improved systems and methods that are configured to quickly (and perhaps more accurately) assist consumers with understanding certain ingredient, nutritional, and environmental information associated with various consumer products (including, but not limited to, foods, cosmetics, washing products, pet products, and others). As the following will demonstrate, the systems and methods of the present invention address such demands in the marketplace.

### SUMMARY OF THE INVENTION

According to certain aspects of the invention, systems and methods for analyzing consumer products (e.g., food products and cosmetics) are provided. The systems generally include a server that houses a central processor and memory facilities, which is operably connected to (i.e., in communication with) a plurality of databases that house product-specific data. The server includes a computing module, which is configured to receive personalized consumer product criteria from each of a plurality of users (e.g., through a centralized website or device application); extract the product-specific data from each of the plurality of databases; and compute a product rating based on the personalized consumer product criteria and product-specific data. The product rating is then communicated and displayed to the user. The invention provides that the product rating preferably includes a rating for individual ingredients (components) associated with the consumer product and an overall rating associated with the consumer product.

According to such aspects of the invention, the product-specific data pertain to label information affixed to consumer products. For food products, the invention provides that such label information may include ingredient information, nutritional data, third party quality ratings, and other information and data that pertain to consumer food products and components thereof. According to certain aspects of the invention, the plurality of databases include data and information provided by consumer protection agencies, governmental food and health organizations, foundations specializing in food and health, scientific organizations, environmental organizations, and other entities that control relevant and unbiased information and data regarding particular consumer products and components thereof. The invention provides that the computing module is configured to compute the product rating based on the personalized consumer product criteria and product-specific data, whereby different types of product-specific data are weighted differently in such computation based on the personalized consumer product criteria (i.e., in accordance with different consumer product criteria weightings prescribed by each user). As such, the variable weighting functionality allows users to prioritize (and de-prioritize) certain types of product criteria (which, in turn, prioritize (and de-prioritize) certain product-specific data extracted from the plurality of databases).

In certain embodiments (but not all), the invention provides that the server is further configured to host a centralized website. According to such aspects of the invention, the product rating is communicated by the system to the user within a graphical user interface of the website. More particularly, the invention provides that the product rating may be, for example, presented as a circle that includes at least two colors, with a first color representing positive attributes of a consumer product and a second color representing negative attributes of a consumer product. In addition, the invention provides that the first color may further be correlated with an extent to which the consumer product satisfies the personalized consumer product criteria of the user (and, conversely, the second color may further be correlated with an extent to which the consumer product does not satisfy the personalized consumer product criteria of the user).

According to yet further aspects of the invention, the personalized consumer product criteria may include a list of problematic ingredients (e.g., ingredients in food or cosmetics that may trigger an allergic response in a particular user), such that the computing module is configured to identify and communicate a presence of such problematic ingredients in a consumer product to a user. As such, different colors (and ratings associated therewith) may be assigned to individual ingredients or product components. Still further, in certain embodiments, the system may be configured to provide alternative consumer products, along with the product rating for the consumer product that is analyzed by the system. In such embodiments, the system may search for and identify similar types of products, which—based on the personalized consumer product criteria and product-specific data—have a higher product rating.

The above-mentioned and additional features of the present invention are further illustrated in the Detailed Description contained herein.

### BRIEF DESCRIPTION OF THE FIGURES

FIG. 1 is a diagram showing the various components of the systems described herein.

FIG. 2 is a diagram showing that the system is configured to analyze products and provide information to multiple users at a time.

FIG. 3 is a diagram showing the type of inputs that may be provided to the system by the plurality of databases that house product-specific data.

FIG. 4 is a diagram showing the type of inputs that a user may provide to the system, to generate a user profile and specify personalized consumer product criteria.

FIG. 5 is flow diagram that generally illustrates the role of the algorithm that is used and executed by the computing module of the system described herein.

FIG. 6 is flow diagram that generally illustrates a hierarchy of databases that the system may use to obtain product-specific data and information.

FIG. 7 is flow diagram that generally illustrates a non-limiting example of the steps undertaken by the system described herein to calculate and provide a user with a product rating for a food product.

FIG. 8 is flow diagram that generally illustrates another (second) non-limiting example of the steps undertaken by the system described herein to calculate and provide a user with a product rating for a food product.

FIG. 9 is flow diagram that generally illustrates a process by which the system may search for and identify alternative products (i.e., products other than a product a user initially analyzes with the system).

### DETAILED DESCRIPTION OF THE INVENTION

The following will describe, in detail, several preferred embodiments of the present invention. These embodiments are provided by way of explanation only, and thus, should not unduly restrict the scope of the invention. In fact, those of ordinary skill in the art will appreciate upon reading the present specification and viewing the present drawings that the invention teaches many variations and modifications, and that numerous variations of the invention may be employed, used and made without departing from the scope and spirit of the invention.

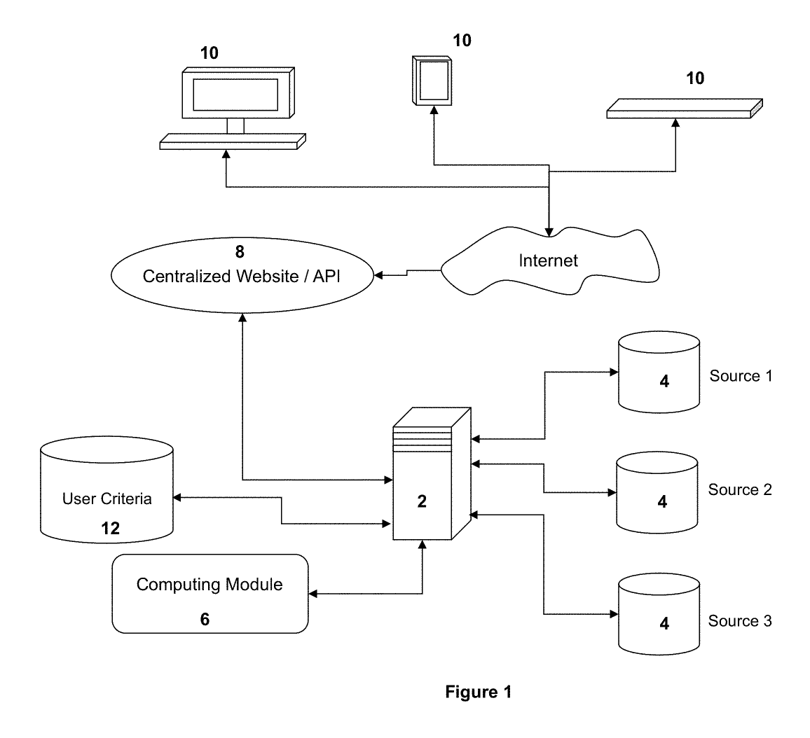

Referring now to FIGS. 1-9, according to certain preferred embodiments of the present invention, systems and methods for analyzing consumer products (e.g., food products and cosmetics) are provided. The systems generally include a server 2 that houses a central processor and memory facilities (e.g., conventional storage, random-access memory (RAM), and other types of memory), which is operably connected to (and in communication with) a plurality of databases 4 that house product-specific data. The invention provides that each of the plurality of databases 4 contains product-specific data and information that are unique to a particular source, as described further below and illustrated in FIG. 1. When the present specification refers to the server 2, the invention provides that the server 2 may comprise a single server or a group of servers. In addition, the invention provides that the system may employ the use of cloud computing, whereby the server paradigm that is utilized to support the system of the present invention is scalable and may involve the use of different servers (and a variable number of servers) at any given time, depending on the number of individuals who are utilizing the system at different time points, which are in fluid communication with the database 4 described herein.

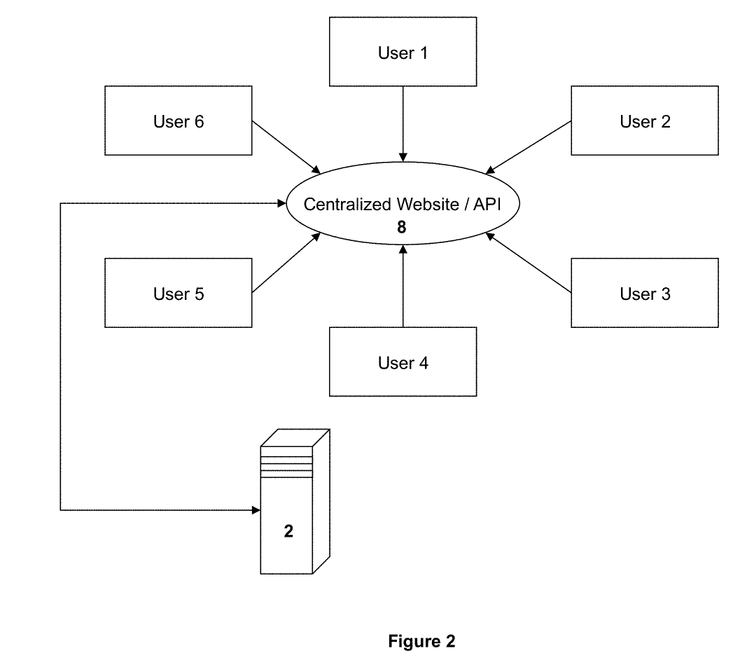

Referring to FIGS. 1 and 2, the server includes a computing module 6, which is configured to receive personalized consumer product criteria from each of a plurality of users (e.g., through a centralized website 8; extract the product-specific data from each of the plurality of databases 4; and compute a product rating based on the personalized consumer product criteria and product-specific data). The product rating is then communicated and displayed to the user. The invention provides that the product rating preferably includes a rating for individual ingredients or components associated with the analyzed consumer product and an overall rating associated with the consumer product. As illustrated in FIGS. 1 and 2, the system of the present invention may be accessed and operated my multiple users (using a variety of devices 10, such as desktop computers, mobile phones, household appliances, e.g., refrigerators, and other types of devices). Alternatively, the invention provides that users may access and operate the system through a computer application that resides on a device 10, e.g., a computer application that a user may download into a device 10 through a centralized website 8 (in such embodiments, a centralized website 8 may include third party platforms, such as an Apple App Store).

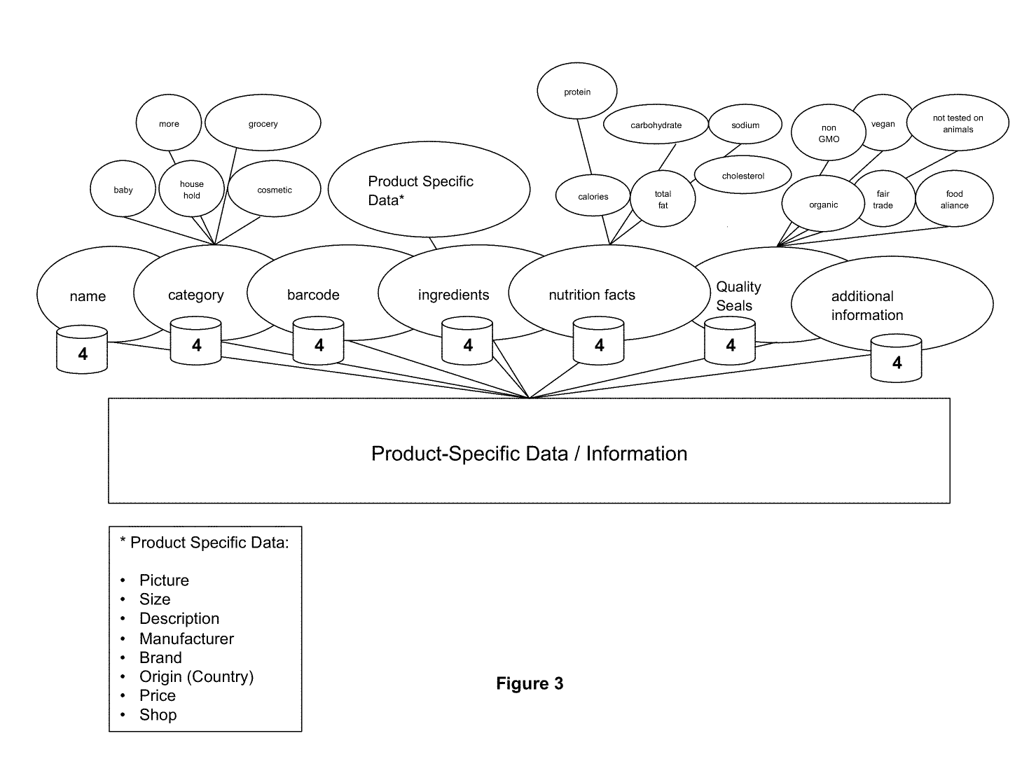

Referring to FIG. 3, according to certain preferred embodiments of the invention, the product-specific data pertain to label information affixed to consumer products. The invention provides that such label information may include, for example, the name of the product, a type or category of product, information associated with or derived from a barcode, ingredient information, nutritional data, third party quality ratings, label designations (e.g., non-GMO, vegan, organic, etc.), and other information and data that pertain to consumer products and components thereof. As mentioned above, and illustrated in FIG. 3, the invention provides that such product-specific data are obtained from multiple databases 4 (sources) and used by the computing module 6 to calculate product ratings as described herein. According to certain embodiments of the invention, the plurality of databases 4 include data and information provided by a variety of sources, such as consumer protection agencies, governmental food and health organizations, foundations specializing in food and health, scientific organizations, and other organizations that control relevant and unbiased information and data regarding particular consumer products and components thereof.

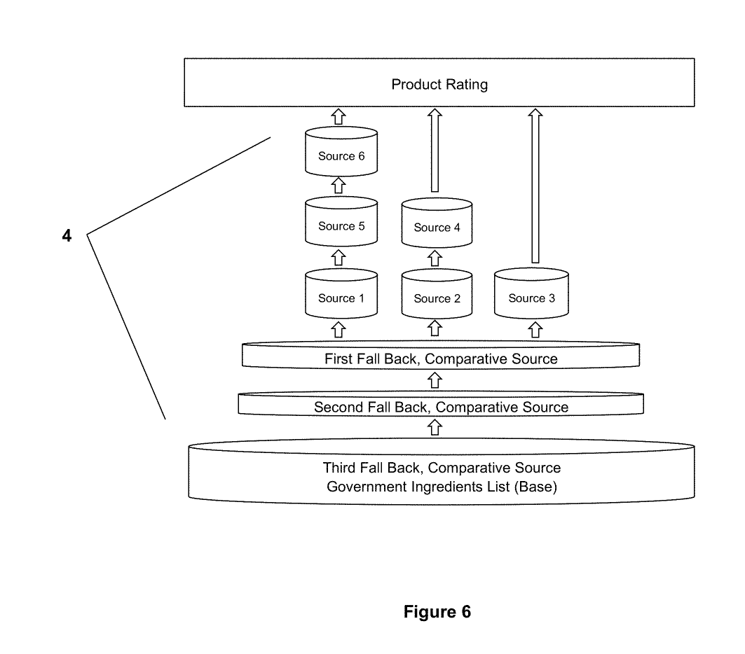

Referring now to FIG. 6, the invention provides that the plurality of databases 4 may exhibit a tiered structure (i.e., a defined hierarchy). For example, for certain types of product-specific data (e.g., the various categories and subparts shown in FIG. 3), the server 2 and computing module 6 may first extract information/data from certain preferred databases 4 (sources). If the preferred databases 4 (sources) do not contain a match or relevant information regarding a particular type of product-specific data, the server 2 and computing module 6 may be configured to consider a secondary/alternative database 4. Likewise, if the secondary/alternative database 4 does not contain a match or relevant information regarding a particular type of product-specific data, the server 2 and computing module 6 may be configured to consider a tertiary/alternative database 4. In addition, the invention provides that when multiple databases 4 include a match or relevant information regarding a particular type of product-specific data, the server 2 and computing module 6 may be configured to consider data and information from all of such databases 4 (and, in such embodiments, the information and data extracted from the multiple databases 4 may be weighted equally or unevenly).

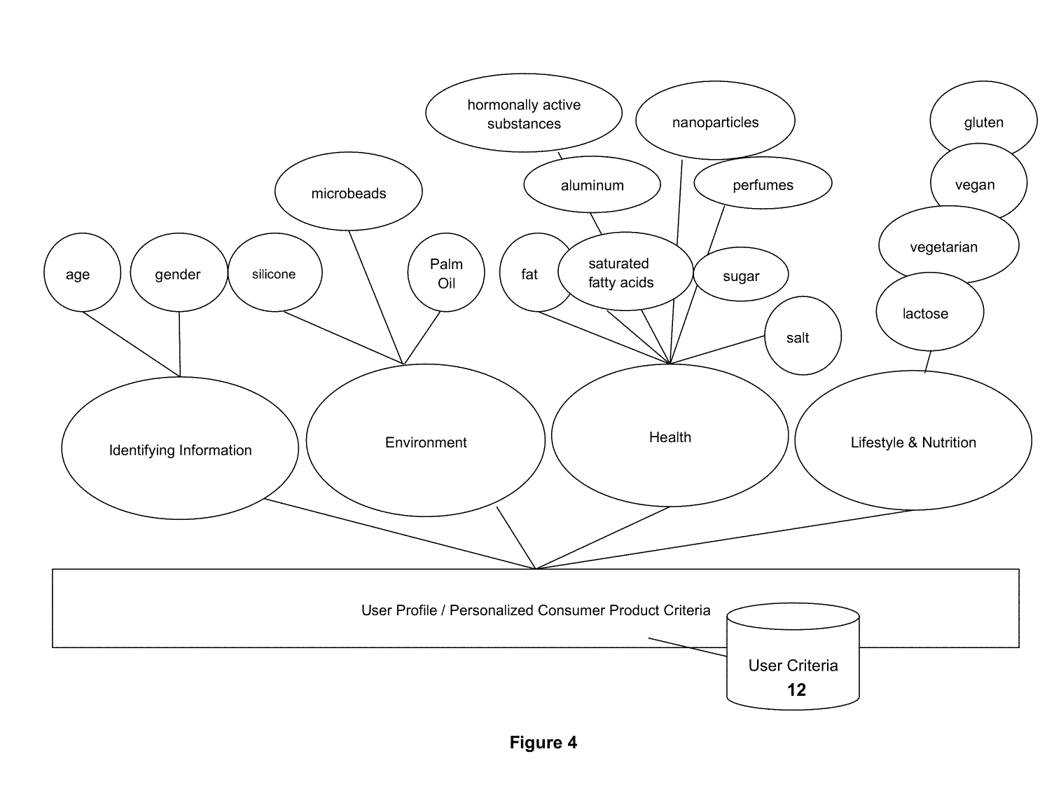

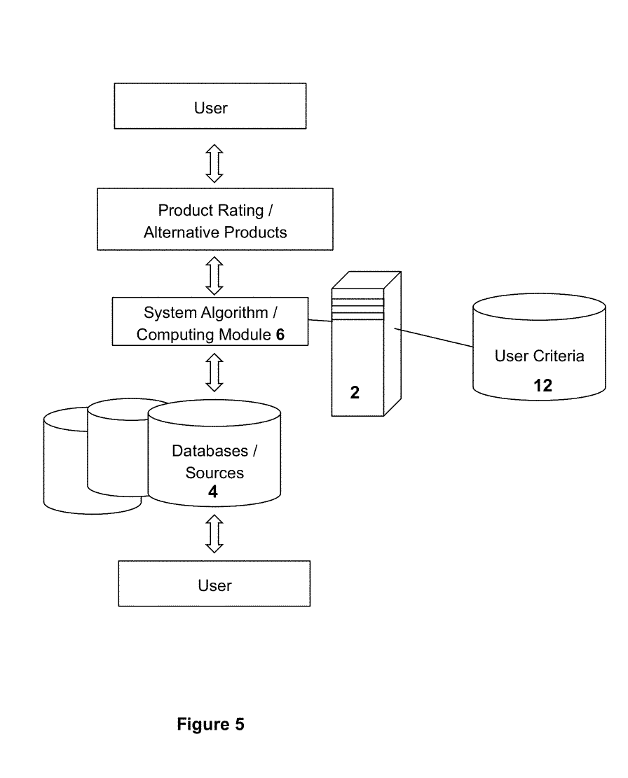

Referring now to FIGS. 4 and 5, the invention provides that the computing module 6 is configured to compute the product rating based on the personalized consumer product criteria and product-specific data. More particularly, the invention provides that different types of product-specific data extracted from the plurality of databases 4 (illustrated in FIG. 3) are weighted differently in such computation based on the personalized consumer product criteria (i.e., in accordance with different consumer product criteria weightings prescribed by each user). In such embodiments, a user may establish a user profile with the system. The user profile will preferably include information that identifies each unique user, along with personalized consumer product criteria that is specified by each user. The user profiles—and personalized consumer product criteria for each user—will preferably and securely be stored in a database 12 that is operably connected to the server 2.

FIG. 4 summarizes the type of information and data that a user may provide to the system, to create a user profile and prescribe personalized consumer product criteria, such as user identifying information; preferences regarding a product component's impact on the environment; health information; and lifestyle/nutrition information. As illustrated in FIG. 4, each of such categories may further include subparts (e.g., for food products, the health information may include subparts related to the presence and amount of fat, saturated fatty acids, sugar, salt, etc. that is contained in a particular food product). The invention provides that a user may identify certain of such categories (and subparts) as being more important than others—e.g., the system is configured to allow a user to assign numeric weighting factors to each of such categories and subparts. The invention provides that this variable weighting functionality allows users to prioritize (and de-prioritize) certain types of product criteria—which, in turn, prioritize (and de-prioritize) certain product-specific data extracted from the plurality of databases 4 (and such weightings are used by the computing module 6 when calculating a product rating).

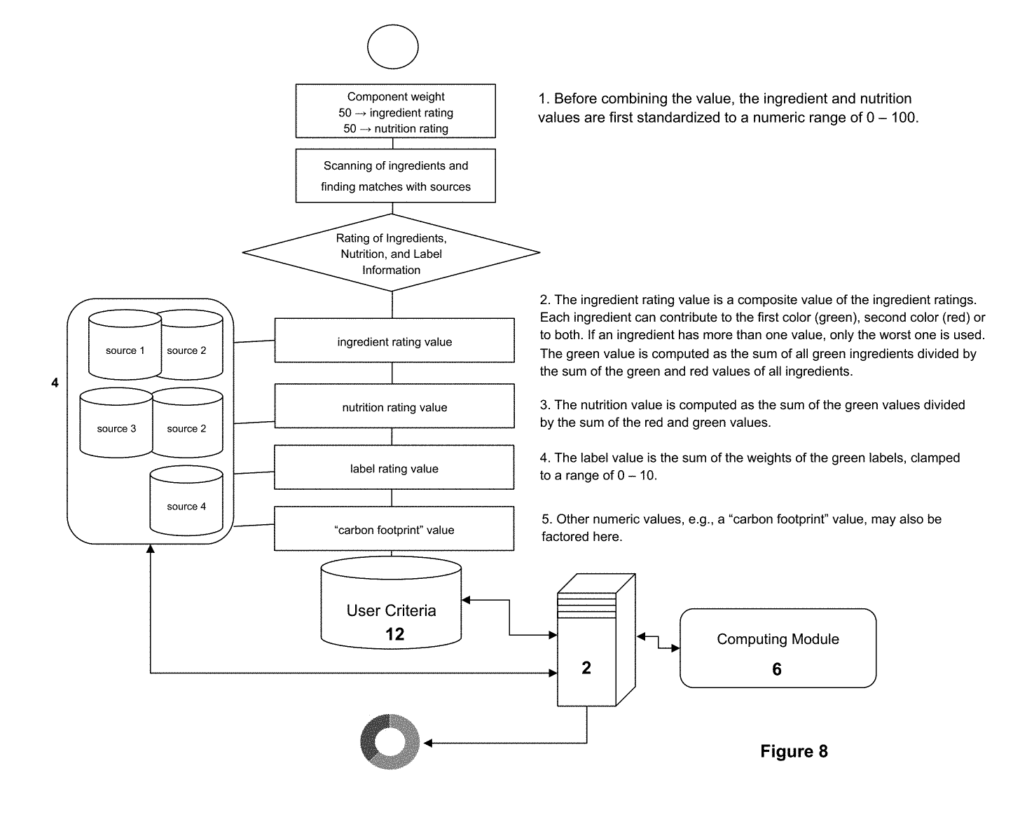

As mentioned above, the invention provides that the server 2 is further configured to host a centralized website 8. According to such embodiments of the invention, the product rating is communicated by the system to the user within a graphical user interface of the website 8. More particularly, the invention provides that the product rating that is generated by the computing module 6 (FIG. 5) may be, for example, presented to the user within a graphical user interface of the centralized website 8. By way of example and illustrated in FIG. 8, according to certain preferred embodiments, the product rating may be presented as a circle that includes at least two colors (e.g., red and green), with a first color representing positive attributes of a consumer product and a second color representing negative attributes of a consumer product. In addition, the invention provides that the first color may further be correlated with an extent to which a consumer product satisfies the personalized consumer product criteria of the user (and, conversely, the second color may further be correlated with an extent to which the consumer product does not satisfy the personalized consumer product criteria of the user). Alternatively, when the system is accessed and used through an application residing on a computing device 10 (as mentioned above), the product rating that is generated by the computing module 6 will be presented within the user interface of such device 10.

According to yet further aspects of the invention, the personalized consumer product criteria may include a list of problematic ingredients (e.g., ingredients in food or cosmetics that may trigger an allergic response in a particular user), such that the computing module 6 is configured to identify and communicate a presence of such problematic ingredients in a consumer product to a user. Still further, in certain embodiments, the system may be configured to provide alternative consumer products, along with the product rating for the consumer product that is analyzed by the system. In such embodiments, the system may search for and identify similar types of products, which—based on the personalized consumer product criteria and product-specific data—the computing module 6 has identified as having a higher product rating.

### EXAMPLES

The following will summarize various non-limiting examples and implementations of the systems and methods described herein.

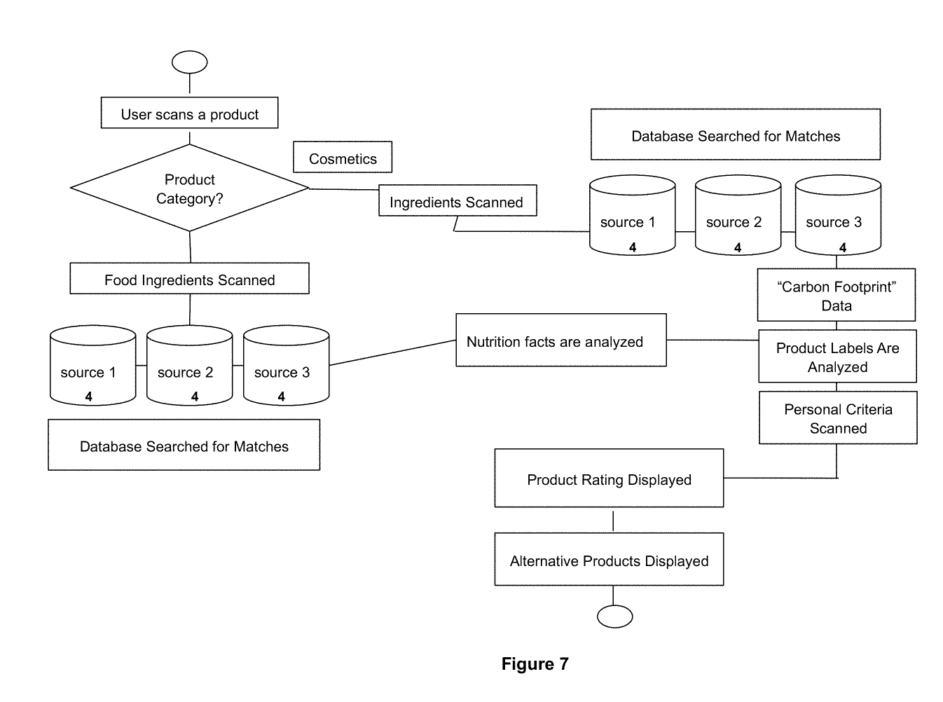

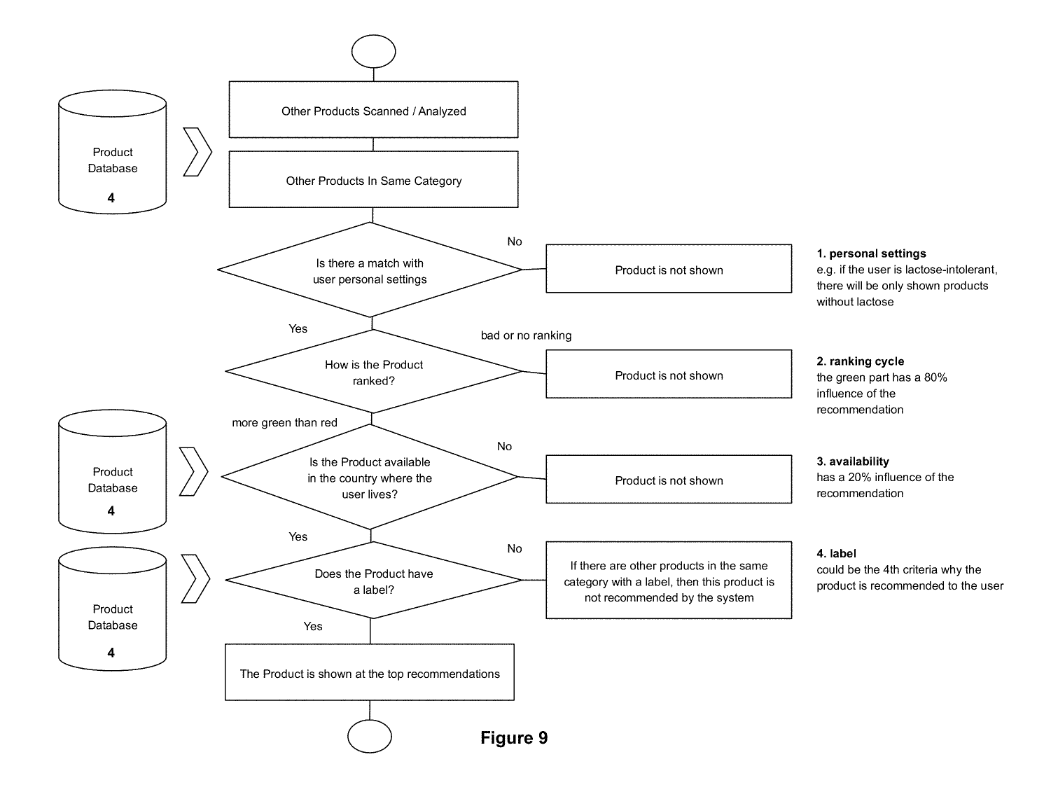

FIG. 7 represents a first non-limiting example of the present invention. In such example, a user scans a product using a device 10 that is capable of detecting and communicating barcode data (or, alternatively, data correlated to an image and/or harvested via text recognition) to the server 2, e.g., a device 10 that is configured to capture an image of a barcode (or image/text) and software that is configured to extract usable data from the image of the barcode (or image/text), such as a numeric code. The server 2 then analyzes the barcode data using a database 4 that informs the server 2 and computing module 6 whether the product is a food product or cosmetic product. The database 4 further informs the server 2 and computing module 6 about the ingredients contained in the food product (or components of the cosmetic product), such that the server 2 and computing module 6 may then conduct additional queries of additional databases 4 to extract product-specific data from the plurality of databases 4. The extracted product-specific data, and weighted personalized consumer product criteria (contained in the user criteria database 12), are then used by the computing module 6 to calculate a product rating (FIG. 5)—and, in certain embodiments, identify alternative products that may exhibit a higher product rating for the particular user (FIG. 9).

FIG. 8 illustrates and summarizes another example of the systems and methods described herein. As shown in FIG. 8, in this example, the user has specified (within the user's profile) that ingredient preferences and nutrition preferences will be given equal weight for the purpose of calculating a product rating (in other examples, the user may prescribe uneven weightings for ingredient preferences and nutrition preferences). In this example, a product label is scanned (as described above) and the system queries one or more databases 4 to calculate an ingredient rating value, a nutrition rating value, and a label rating value. In this example, the user criteria specify the types of ingredients that should be accorded a positive value (a green rating) and the types of ingredients that should be accorded a negative value (a red rating). In this example, the ingredient rating value represents a sum of all green ingredients, divided by the sum of the total number of green and red ingredients (the nutritional value rating is calculated using the same methodology). In this example, the label rating value represents a sum of the weights that have been prescribed by the user (in the user criteria database 12) for each of the green ingredients. The server 2 and computing module 6 then use the ingredient rating value, a nutrition rating value, and a label rating value to calculate a composite product rating.

The product rating is then communicated to the user, in this example, by displaying a circle (as described above) that includes at least two colors (i.e., red and green), with the green color being correlated with an extent to which a product satisfies the personalized consumer product criteria of the user (and, conversely, the red color is correlated with an extent to which the product does not satisfy the personalized consumer product criteria of the user). The product rating may also be communicated and displayed to the user along with the individual ingredient rating value, nutrition rating value, and label rating value. Still further, as mentioned above, the product rating may also be communicated and displayed to the user along with alternative products—e.g., similar types of products that may be available for purchase that exhibit a higher product rating. FIG. 9 summarizes the process by which the system may search for and identify such alternative products. As shown in FIG. 9, in addition to the product ratings for such alternative products, the server 2 and computing module 6 may further consider user criteria (personalized consumer product criteria), product availability, and whether an alternative product includes a suitable label in identifying and communication alternative products to a user (and such additional factors may be accorded different weights by the system and/or user).

The many aspects and benefits of the invention are apparent from the detailed description, and thus, it is intended for the following claims to cover all such aspects and benefits of the invention that fall within the scope and spirit of the invention. In addition, because numerous modifications and variations will be obvious and readily occur to those skilled in the art, the claims should not be construed to limit the invention to the exact construction and operation illustrated and described herein. Accordingly, all suitable modifications and equivalents should be understood to fall within the scope of the invention as claimed herein.

What is claimed is:

1. A system for analyzing consumer products, which comprises:
(a) a server that includes a central processor and memory facilities;
(b) a plurality of databases that house product-specific data in communication with the server;
(c) a computing module, located within the server, wherein the computing module is configured to (i) receive personalized consumer product criteria from each of a plurality of users; (ii) extract the product-specific data from each of the plurality of databases; and (iii) compute a product rating based on the personalized consumer product criteria and product-specific data.

2. The system of claim 1, wherein the product-specific data pertain to and are correlated with label information affixed to consumer products.

3. The system of claim 2, wherein the label information comprises ingredient information, nutritional data, and quality ratings.

4. The system of claim 1, wherein the product rating includes a rating for individual ingredients associated with the consumer product and an overall rating associated with the consumer product.

5. The system of claim 1, wherein the plurality of databases comprise data provided by consumer protection agencies, governmental food and health organizations, foundations specializing in food and health, and scientific organizations.

6. The system of claim 1, wherein the computing module computes the product rating based on the personalized consumer product criteria and product-specific data, wherein different types of product-specific data are weighted differently in such computation based on the personalized consumer product criteria.

7. The system of claim 1, wherein the server is further configured to host a centralized website.

8. The system of claim 7, wherein the product rating is communicated by the system to the user within a graphical user interface of the website, wherein the product rating is presented as a circle comprising at least two colors, wherein a first color is correlated with positive attributes of a consumer product and a second color is correlated with negative attributes of a consumer product.

9. The system of claim 8, wherein the first color is further correlated with an extent to which the consumer product satisfies the personalized consumer product criteria of the user.

10. The system of claim 9, wherein the second color is further correlated with an extent to which the consumer product does not satisfy the personalized consumer product criteria of the user.

11. The system of claim 1, wherein the personalized consumer product criteria include a list of problematic ingredients, such that the computing module is configured to identify and communicate a presence of such problematic ingredients in a consumer product to a user.

12. The system of claim 1, wherein the consumer products are food products and cosmetics.
